(19) United States
(12) Patent Application Publication
(10) Pub. No.: US 2008/0156294 A1
(43) Pub. Date: Jul. 3, 2008

(54) Fuel Delivery System For An Internal Combustion Engine

(76) Inventors: Oliver ALBRECHT, Bietigheim-Bissingen (DE); Bernd SCHROEDER, Esslingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/964,426

(22) Filed: Dec. 26, 2007

(30) Foreign Application Priority Data
Dec. 27, 2006 (DE) 10 2006 061 558.1

(51) Int. Cl. F02M 59/00

(52) U.S. Cl. 123/446

(57) ABSTRACT

A fuel delivery system for an internal combustion engine includes a piston pump with a work chamber and an inlet valve. An adjustable throttle restriction is disposed upstream of the inlet valve. It is proposed that an outlet of the throttle restriction be disposed immediately adjacent the inlet valve.

### REFERENCE TO FOREIGN PATENT APPLICATION

This application is based on German Patent Application No. 10 2006 061 558.1 filed 27 Dec. 2006, upon which priority is claimed.

### BACKGROUND OF THE INVENTION

1. Field of the Invention

The invention relates to a fuel delivery system for an internal combustion engine.

2. Description of the Prior Art

From German Patent Disclosure DE 102 20 281 A1, a fuel system for an internal combustion engine is known in which fuel is delivered from a preferred pump to a high-pressure pump and from there to a high-pressure fuel rail. The supply quantity of the high-pressure pump, the pump being driven mechanically by the engine, is determined by a throttle restriction located fluidically upstream. The throttle restriction is mounted on a housing of the high-pressure pump and together with it forms a fuel delivery system.

### OBJECT AND SUMMARY OF THE INVENTION

The object of the present invention is to create a fuel delivery system that can be produced in a simple way and allows precise adjustment of the supply quantity.

According to the invention, it has been recognized that in many situations in operation, a pressure downstream of the throttle restriction prevails that is less than the pilot pressure prevailing upstream of the throttle restriction. This promotes the formation of vapor bubbles, especially at higher temperatures, in the region located between the throttle restriction and the inlet valve. That in turn can adversely affect the regulating performance of the fuel delivery system. The provisions according to the invention minimize the hydraulic volume between the throttle restriction and the inlet valve. In particular, idle volumes in this region, in which for a lack of a flow through the area a temperature increase with attendant vapor bubble formation is promoted, are reduced or avoided. As a result, markedly better regulating dynamics and precision are attained in adjusting the supply quantity of the fuel delivery system by means of the throttle restriction.

In a first refinement, it is proposed that the throttle restriction and inlet valve are disposed in a common, one-piece housing. As a result, the production of the fuel delivery system, especially with regard to the short distance between the throttle restriction and the inlet valve, is simplified.

It is especially preferred if an outlet of the throttle restriction discharges into an annular chamber that is located directly opposite the inlet valve. This leads to a further reduction of idle volumes.

A housing of the throttle restriction can be inserted into an opening in the common housing, centered in a press fit in the opening via a first collar, and welded to the common housing via a second collar, which relative to the common housing has a clearance fit and is adjacent to the first collar. This prevents the seat of the housing of the throttle restriction from being altered by the welding operation. The welding operation itself is furthermore simplified.

Another refinement provides that a valve slide of the throttle restriction is guided in a housing of the throttle restriction and defines an idle volume, facing away from an inlet of the throttle restriction; and that the idle volume communicates fluidically with the inlet of the throttle restriction. The fundamental result is that the entire internal region of the throttle restriction is hydraulically connected to the pilot pressure that prevails at the inlet of the throttle restriction. Since in this internal region pilot pressure thus prevails, vapor bubble formation here as well is maximally avoided. Furthermore, this refinement has the advantage that friction pairings, for instance of the valve slide and the housing of the throttle restriction, or of a magnet needle and an associated bearing, are located in a region that is filled with fluid, as a result of which friction, and in the final analysis wear, are minimized. In an electromagnetically driven throttle restriction, this is true above all of the region of a magnet coil that is present in that case, since the power loss from such a magnet coil can cause a local increase in temperature.

It is furthermore proposed that the idle volume communicates with the inlet fluidically through a connection opening, extending overall in the longitudinal direction of the valve slide, and the connection opening includes a damping throttle restriction. As a result, the fact is taken into consideration that the throttle restriction can be strained by jarring stresses caused particularly by the engine. A jarring stress in the range of the resonant frequency of the throttle restriction is especially critical; this load results from the mass being moved (for instance, the valve slide, magnet needle, magnet armature, etc.) and the spring stiffness of a spring element that acts on the valve slide. In the worst case, the valve slide can begin to vibrate, with adverse effects on the regulating precision and the wear. According to the invention, such mechanical natural vibration of the mass being moved is hydraulically damped. In an electromagnetically actuated throttle restriction, for instance, such a damping throttle restriction may for instance be provided in the magnet armature as well.

A valve slide of the throttle restriction can be guided by means of at least one bearing at least indirectly in a housing of the throttle restriction. It is proposed that the bearing communicates fluidically with an inlet of the throttle restriction. Once again, friction and wear are minimized as a result, since the bearing is lubricated by the fuel.

A further preferred feature of the fuel delivery system of the invention provides that a valve slide of the throttle restriction is acted upon by a spring, which is braced on a spring plate that in turn is retained on a housing of the throttle restriction; and that the two sides of the spring plate communicate with one another fluidically and at least essentially without throttling. In other words, the spring plate is pressure-balanced, so that it needs to absorb only the reaction force of the spring and can accordingly be designed to be small in size. A further advantage is that for instance whenever the spring plate is retained by a press fit on the housing of the throttle restriction, the pressure can be kept relatively slight, so that the attendant deformation of the housing can be minimized and hence the influence on the guidance of the valve slide can be kept slight. This has a favorable effect on leakage from the throttle restriction in its closed state, which is known by the term “zero feed”.

A refinement in which there is an encompassing decoupling groove in the housing of the throttle restriction, between the spring plate and a guide portion for the valve slide, points in the same direction. Once again, this reduces the effects of the press fit of the spring plate in the housing of the throttle restriction on the guidance of the valve slide in the housing. In the final analysis, this lessens adverse effects of the production and assembly process on the tightness of the (closed) throttle restriction.

The positive effect just described can be still further amplified by providing that a housing of the throttle restriction includes at least one guide portion for a valve slide, which is located at least essentially outside a sealing region by means of which the housing of the throttle restriction is sealed off from the common housing.

If there is a spot face in a housing of the throttle restriction, in the region of a control opening, or in other words the housing of the throttle restriction is locally weakened there, then on the one hand the control opening can be dimensioned precisely, without on the other hand an attendant unfavorable influence on the rigidity of the housing. Typically, to attain a good fit of the valve slide with the housing of the throttle restriction, the guide portion of the housing is honed. Because of the honing pressure, the housing is widened elastically during the honing process. So that this widening will be uniform, abrupt changes in rigidity must be avoided if at all possible, and this is attained by the aforementioned spot face.

A further advantageous feature of the fuel delivery system of the invention provides that the throttle restriction includes a valve slide having a control edge and at least one control opening, and the end face of the valve slide, in the region of the control edge, has a curved flow guide portion. This is based on the recognition that the valve slide experiences an axial oncoming flow, but the outgoing flow is typically radially outward, through control openings that are present in the cylindrical housing. The result at the valve slide is a flow force that can cause an impermissible deviation in the position of the slide. By the provision of the invention, this flow force is minimized, since by this provision flow losses that are caused by the deflection are reduced.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 is a schematic illustration of an internal combustion engine, with a fuel system including a fuel delivery system;

FIG. 2 is a fragmentary section through the fuel delivery system of FIG. 1;

FIG. 3 shows a detail III of FIG. 2;

FIG. 4 is a perspective view of a throttle restriction of the fuel delivery system of FIG. 1; and

FIG. 5 is a section through a region of the throttle restriction of FIG. 4, in a slightly modified embodiment.

### DESCRIPTION OF THE PREFERRED EMBODIMENTS

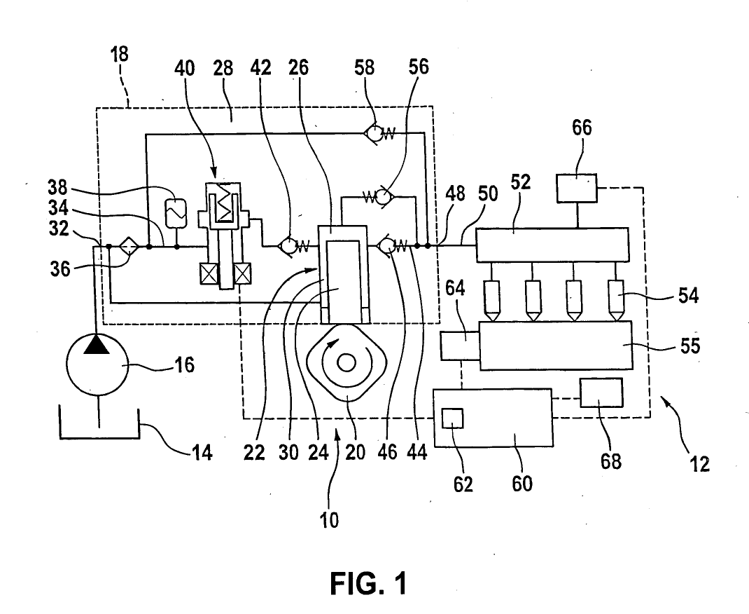

A fuel system in FIG. 1 is identified overall by reference numeral 10. The associated internal combustion engine is marked 12.

The fuel system 10 includes a tank 14, from which a preferred pump 16 delivers fuel to a fuel delivery system 18. The fuel delivery system includes a high-pressure piston pump 22, driven mechanically by a camshaft 20 of the engine 12, with a pump piston 24 that defines a work chamber 26 and that is guided in sliding fashion in a housing 28 of the fuel delivery system 18. Between the housing 28 and the pump piston 24, there is a guide gap 30.

From an inlet 32 of the fuel delivery system 18, an inlet conduit 34 leads to the work chamber 26, via a filter 36, a pressure fluctuation damper 38, a throttle restriction 40 also known as a “metering unit”, and an inlet valve 42. The pressure fluctuation damper 38 is intended to damp pulsation of the high-pressure piston pump 22 that can occur in the inlet conduit 34. It is also intended to assure high efficiency of the high-pressure piston pump 22 even at high rpm and high camshaft rotations. From the work chamber 26, an outlet conduit 44 leads via an outlet valve 46 to an outlet 48 of the fuel delivery system 18. A high-pressure line 50 is connected to this outlet and communicates with a common rail 52. A plurality of injectors 54 are connected in turn to the common rail and inject the fuel directly into combustion chambers 55, associated with them, of the engine 12.

For limiting a maximum pressure in the common rail 52, a pressure limiting valve 56 is disposed between the outlet conduit 44 and the work chamber 26. In normal operation, this valve remains closed. Only in the event of a malfunction, for instance if too much fuel is pumped into the common rail 52 by the fuel delivery system 18, does the pressure limiting valve 56 limit the pressure in the common rail 52 to a defined maximum value. A bypass valve 58 is also disposed parallel to the throttle restriction 40 and to the high-pressure piston pump 22; it connects the outlet conduit 44, in the open state, to the inlet conduit 34 between the filter 36 and the pressure fluctuation damper 38. In normal operation of the engine 12, the bypass valve 58 is closed, because of the high pressure in the common rail 52 and in the outlet conduit 44. However, if in the event of a malfunction the throttle restriction 40 is stuck in a closed position, and hence intrinsically no further fuel can be delivered by the fuel delivery system 18, then fuel can reach the common rail 52 via the bypass valve 58. Emergency operation is thus possible to a certain extent, namely employing the pilot pressure that is furnished by the preferred pump 16.

In normal operation, the preferred pump 16 pumps the fuel at a certain pressure to the throttle restriction 40. Depending on how much is injected by the injectors 54, the throttle restriction 40 allows a greater or lesser quantity of fuel to reach the work chamber 26 via the inlet valve 42. In this way, the fuel delivery system 18 can deliver different quantities of fuel. To that end, the throttle restriction 40 is triggered by a control and regulating device 60, which includes an electrical memory 62 in which a computer program is stored that serves to trigger the throttle restriction 40. For that purpose, the control and regulating device 60 receives signals from various sensors, such as an rpm sensor 64, which detects an rpm of a crankshaft of the engine 12, a pressure sensor 66, which detects the pressure prevailing in the common rail 52, and a temperature sensor 68, which detects a temperature of the engine 12.

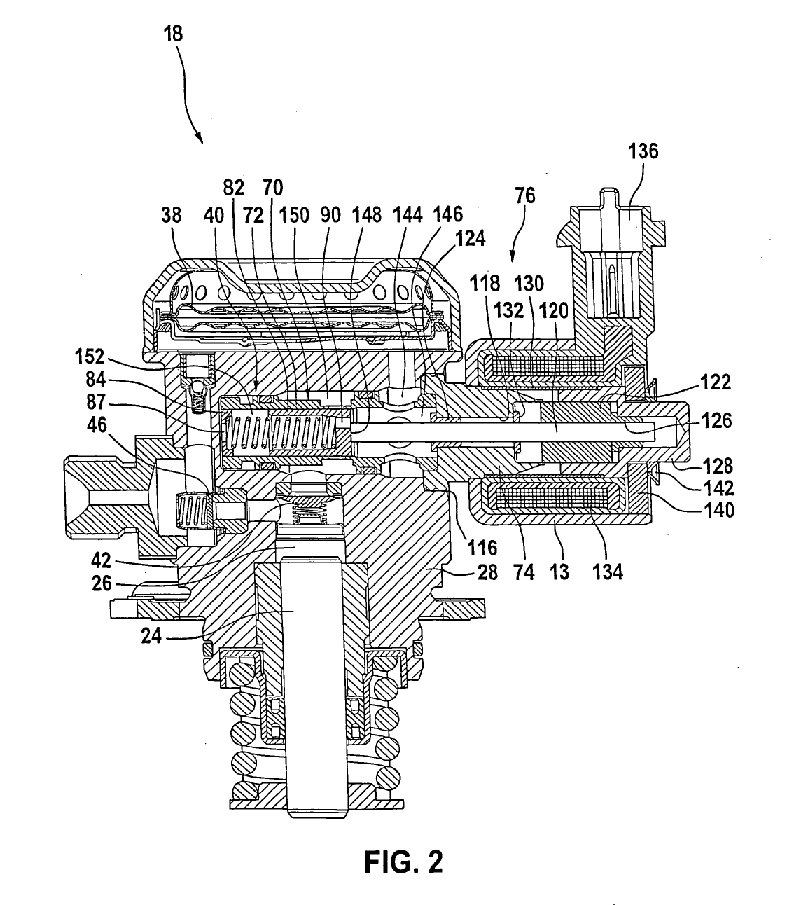

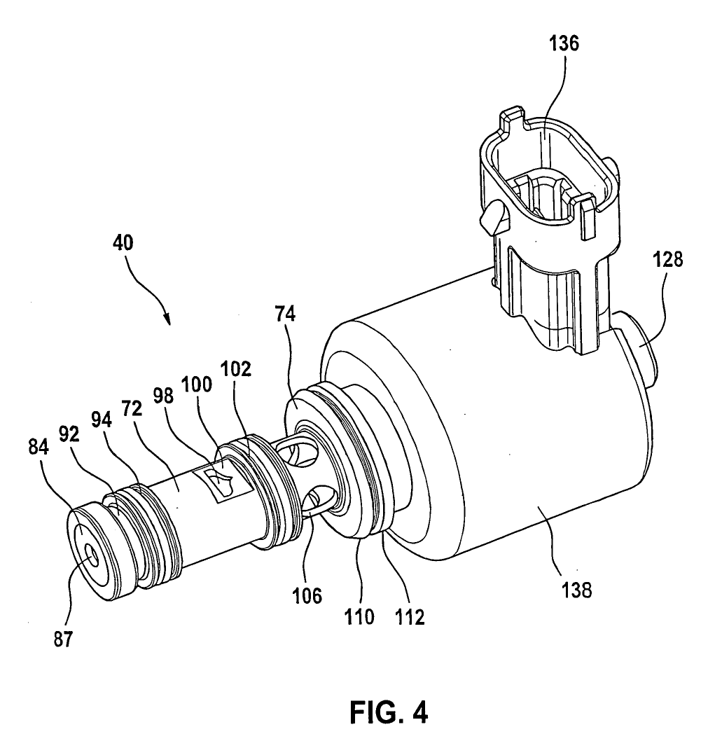

Details of the fuel delivery system 18, and in particular of the throttle restriction 40 and the inlet valve 42 in turn, will now be described in conjunction with FIGS. 2 through 4 (although for the sake of simplicity, not all the reference numerals are shown in FIG. 2):

The throttle restriction 40 includes a cylindrical housing 70, which in turn includes a control sleeve 72 and a fastening piece 74. Via the fastening piece 74, in a manner to be described hereinafter, the throttle restriction 40 is secured to the housing 28 of the fuel delivery system 18. An electromagnetic actuation unit 76 is secured in turn to the fastening piece 74.

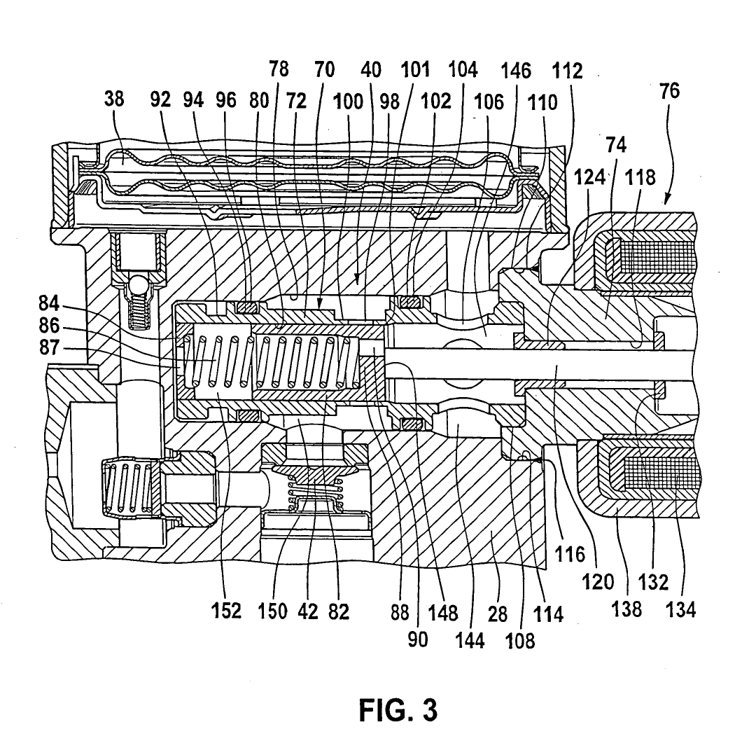

The control sleeve 72 is located in a blind bore 78 in the housing 28. The interior of the control sleeve 72 includes a honed guide portion 80, which extends in some regions in the longitudinal direction of the control portion 72, and in which a pistonlike valve slide 82 is guided. A spring plate 84, which is pressed together with the control sleeve 72 and on which a spring 86 is braced whose other end acts in turn on the pistonlike valve slide 82, is disposed on the left-hand end of the control sleeve 72, in terms of FIGS. 2 and 3. In the spring plate 84, there is a central opening 87, which connects the two sides of the spring plate 84 fluidically and at least essentially without throttling. A bottom 88 of the valve slide 82 is pierced by an eccentrically disposed connection opening 90, which is simultaneously embodied as a hydraulic damping throttle restriction.

On the outside of the control sleeve 72 of the housing 70 of the throttle restriction 40, there is an encompassing decoupling groove 92, axially between the spring plate 84 and the guide portion 80. By means of this groove, deformation of the guide portion 80 that occurs as the spring plate 84 is pressed in the control sleeve 72 is kept away from the guide portion 80. Right next to the decoupling groove 92, there is a first receiving groove 94 for a first ring seal 96 in the outer jacket face of the control sleeve 72. Axially still farther to the right thereof, the control sleeve 72 has control openings 98 that form outlets, and in the region of these openings, the outer jacket face of the control sleeve 72 is flattened by a flat face 100. The control openings 98 cooperate with a control edge 101, which is embodied on the right-hand end of the valve slide 82 in terms of FIGS. 2 and 3. Still farther to the right of the control openings 98, there is a second receiving groove 102 for a second ring seal 104 in the outer jacket face of the control sleeve 72. To the right of this groove, the control sleeve 72 has a plurality of inlet opening s 106, distributed over its circumference.

The fastening piece 74 of the cylindrical housing 70 is connected solidly to the control sleeve 72 on its right-hand end, for instance by means of a press connection or crimping. The corresponding connection region is marked 108 and is spaced apart from the guide portion 80, in which the valve slide 82 is guided, so far that in the production of the connection between the fastening piece 74 and the control sleeve 72, deformation of the guide portion 80 is maximally avoided.

The fastening piece 74, on its end toward the control sleeve 72, has a radially protruding, encompassing annular portion (without a reference numeral) that is provided with two encompassing annular collars 110 and 112 that are spaced apart from one another. The fastening piece 74 is inserted with the annular portion into an outer region 114 of the blind bore 78 in the housing 28. The annular collar 110 on the left in FIG. 3 has a press fit with regard to the outer region 114 of the blind bore 78. The second annular collar 112, on the right in FIG. 3, conversely has a clearance fit with regard to the region 114 of the blind bore 78. The annular collar 112 is connected to the housing 28 by means of a weld seam 116. Upon assembly via the first pressed annular collar 110, centering on the one hand and a fixation on the other for the application of the weld seam 116 are attained. The weld seam 116 absorbs the operating forces and assures sealing off from the outside.

The fastening piece 74 is pierced by a through bore 118, through which a magnet needle 120 is passed. The end of this needle located in the region of the control sleeve 72 is connected to the valve slide 82; the other end, located in the region of the electromagnetic actuation unit 76, is connected to a magnet armature 122. The magnet needle 120 is guided on both sides of the magnet armature 122 by bearing points 124 and 126. The bearing point 124 is located in the fastening piece 74, and the bearing point 126 is located in an end piece 128. The end piece 128 and the fastening piece 74 are solidly connected to one another via a sleeve 130. A remnant air gap disk 132 serves as a front stop for the magnet armature 122.

The magnetic force is generated by a magnet coil 134, which is supplied with voltage via an electrical terminal 136. The magnet coil 134 is located in a housing jacket 138 that is pressed onto the fastening piece 74. For the magnetic short circuit, a termination plate 140 is joined to the end piece 128. A zigzag ring 142 is pressed onto the end piece 128 and holds the termination plate 140. The throttle restriction 40 is “closed when without current”; that is, in the state when no current is supplied to the magnet coil 134, the valve slide 82 by the force of the spring 86 assumes a position in which the control edge 101 covers the control openings 98, or in other words these openings are closed. This is shown in FIGS. 2 and 3.

By the arrangement described above, an annular inlet chamber 144 is created in the region of the inlet opening s 106, which is defined radially by the housing 28 and the wall of the control sleeve 72 and axially above all by the ring seal 104 in the fastening piece 74. In the interior of the control sleeve 72, in the region of the inlet opening s 106, a control chamber 146 is formed, which is defined radially by the wall of the control sleeve 72 and axially by an end face 148 of the valve slide 82 and by the bearing point 124. Outside of the control openings 98, an annular outlet chamber 150 is formed between the wall of the control sleeve 72, the housing 28, and the two ring seals 96 and 104. The chamber enclosed between the spring plate 84, the valve slide 82, and the wall of the control sleeve 72 define a part of an idle volume 152, which extends onward, via the opening 87 in the spring plate 84, as far as the decoupling groove 92 and the ring seal 96. Via the connection opening 90, the idle volume 152 communicates with the control chamber 146.

In operation, the fuel flows from the pressure fluctuation damper 38 via the inlet conduit 34 into the annular inlet chamber 144 and onward via the inlet opening s 106 into the control chamber 146. Depending on the position of the valve slide 82 and of the control edge 111, the fuel flows onward via the control openings 98 into the annular outlet chamber 150, and from there to the directly adjacent inlet valve 42. It can be appreciated that the volume between the throttle restriction 40 and the inlet valve 42 is minimal, since this volume essentially comprises the annular outlet chamber 150. It can also be appreciated that the pilot pressure generated by the preferred pump 16 prevails in the idle volume 152 as well, since the idle volume communicates with the inlet conduit 34 via the connection opening 90, the control chamber 146, and the annular inlet chamber 144. Overall, approximately the same pressure prevails on both sides of the valve slide 82, namely the pilot pressure, so that the valve slide 82 is hydraulically pressure-balanced. Furthermore, because the connection opening 90 is embodied as a damping throttle restriction, vibration of the valve slide 82 caused for instance by vibration of the fuel delivery system 18 is lessened.

It can also be appreciated that the region of the magnet coil 134 communicates with the inlet conduit 34 via the control chamber 146, since neither the bearing points 124 and 126 nor the remnant air gap disk 132 bring about any fluid sealing. The magnet armature 122 and the magnet needle 120 accordingly operate within fluid, which minimizes both friction and wear. It can also be seen from the drawings that the ring seals 96 and 104, like the communicating regions of the control sleeve 72, with the spring plate 84 on the one hand and the fastening piece 74 on the other, are spaced apart far enough from the guide portion 80 in the control sleeve 72 that deformation of the guide portion 80 during assembly is minimized or even prevented entirely. Hence the fit between the valve slide 82 and the guide portion 80 can be embodied as quite narrow, and thus a high degree of tightness can be established between the valve slide 82 and the control sleeve 72.

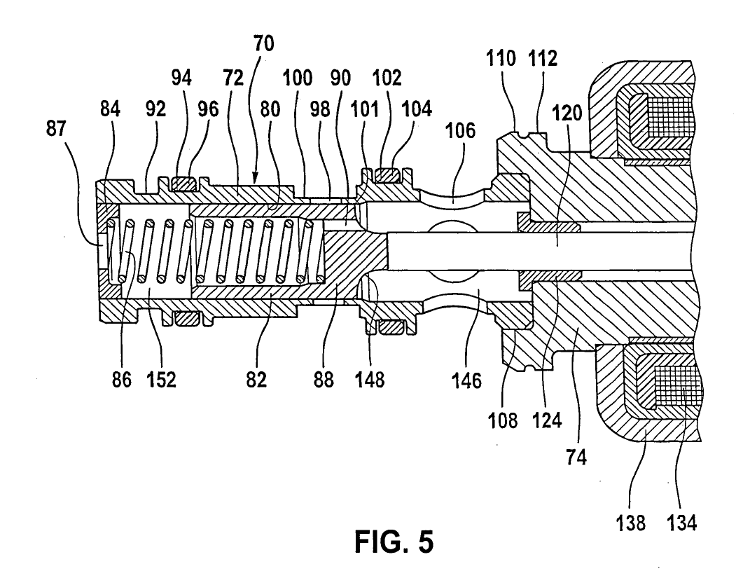

A slightly modified embodiment of a throttle restriction is shown is shown in FIG. 5. Those elements and regions that have equivalent functions to elements and regions already described are identified by the same reference numerals and will not be described again.

The throttle restriction 40 shown in FIG. 5 differs from that shown in FIGS. 2 through 4 above all in the design of the end face 148 of the valve slide 82. Specifically, in the embodiment shown in FIG. 5, this face is embodied as a curved flow guide portion, which when the throttle restriction 40 is at least partially open deflects the flow, with relatively little loss, out of the control chamber 146 to the control openings 98 and to the annular outlet chamber 150. As a result, the force exerted on the valve slide 82 by the flow can be reduced.

The foregoing relates to preferred exemplary embodiments of the invention, it being understood that other variants and embodiments thereof are possible within the spirit and scope of the invention, the latter being defined by the appended claims.

We claim:

1. A fuel delivery system for an internal combustion engine of a motor vehicle, the system comprising a piston pump having a work chamber and an inlet valve, an adjustable throttle restriction disposed fluidically upstream of the inlet valve, and an outlet of the throttle restriction disposed immediately adjacent to the inlet valve.

2. The fuel delivery system as defined by claim 1, wherein the throttle restriction and inlet valve are disposed in a common, one-piece housing.

3. The fuel delivery system as defined by claim 2, wherein the outlet of the throttle restriction discharges into an annular chamber located directly opposite the inlet valve.

4. The fuel delivery system as defined by claim 2, wherein the throttle restriction comprises a housing inserted into an opening in the common housing, the throttle restriction housing being centered in a press fit in the opening via a first collar on the throttle restriction housing and welded to the common housing via a second collar, which relative to the common housing has a clearance fit and is adjacent to the first collar.

5. The fuel delivery system as defined by claim 3, wherein the throttle restriction comprises a housing inserted into an opening in the common housing, the throttle restriction housing being centered in a press fit in the opening via a first collar on the throttle restriction housing and welded to the common housing via a second collar, which relative to the common housing has a clearance fit and is adjacent to the first collar.

6. The fuel delivery system as defined by claim 1, wherein the throttle restriction comprises a housing and a valve slide guided in the housing of the throttle restriction and defining an idle volume, facing away from an inlet of the throttle restriction, and wherein the idle volume communicates fluidically with the inlet of the throttle restriction.

7. The fuel delivery system as defined by claim 3, wherein the throttle restriction comprises a housing and a valve slide guided in the housing of the throttle restriction and defining an idle volume, facing away from an inlet of the throttle restriction, and wherein the idle volume communicates fluidically with the inlet of the throttle restriction.

8. The fuel delivery system as defined by claim 6, wherein the idle volume communicates with the inlet fluidically through at least one connection opening, extending overall in the longitudinal direction of the valve slide, and wherein the connection opening includes a damping throttle restriction.

9. The fuel delivery system as defined by claim 7, wherein the idle volume communicates with the inlet fluidically through at least one connection opening, extending overall in the longitudinal direction of the valve slide, and wherein the connection opening includes a damping throttle restriction.

10. The fuel delivery system as defined by claim 1, wherein the throttle restriction comprises a housing and a valve slide, the valve slide being guided by means of at least one bearing at least indirectly in the housing of the throttle restriction, and wherein the at least one bearing communicates fluidically with an inlet of the throttle restriction.

11. The fuel delivery system as defined by claim 2, wherein the throttle restriction comprises a housing and a valve slide, the valve slide being guided by means of at least one bearing at least indirectly the housing of the throttle restriction, and wherein the at least one bearing communicates fluidically with an inlet of the throttle restriction.

12. The fuel delivery system as defined by claim 3, wherein the throttle restriction comprises a housing and a valve slide, the valve slide being guided by means of at least one bearing at least indirectly the housing of the throttle restriction, and wherein the at least one bearing communicates fluidically with an inlet of the throttle restriction.

13. The fuel delivery system as defined by claim 1, wherein the throttle restriction comprises a housing, a spring plate retained on the housing, a slide valve, and a spring plate braced on the housing and acting on the valve slide and wherein the two sides of the spring plate communicate with one another fluidically and at least essentially without throttling.

14. The fuel delivery system as defined by claim 2, wherein the throttle restriction comprises a housing, a spring plate retained on the housing, a slide valve, and a spring plate braced on the housing and acting on the valve slide and wherein the two sides of the spring plate communicate with one another fluidically and at least essentially without throttling.

15. The fuel delivery system as defined by claim 3, wherein the throttle restriction comprises a housing, a spring plate retained on the housing, a slide valve, and a spring plate braced on the housing and acting on the valve slide and wherein the two sides of the spring plate communicate with one another fluidically and at least essentially without throttling.

16. The fuel delivery system as defined by claim 1, wherein the throttle restriction comprises a valve slide acted upon by a spring braced on a spring plate that in turn is retained in a cylindrical housing of the throttle restriction in a press fit, and an encompassing decoupling groove in the housing of the throttle restriction between the spring plate and a guide portion for the valve slide.

17. The fuel delivery system as defined by claim 2, wherein the throttle restriction comprises a valve slide acted upon by a spring braced on a spring plate that in turn is retained in a cylindrical housing of the throttle restriction in a press fit, and an encompassing decoupling groove in the housing of the throttle restriction between the spring plate and a guide portion for the valve slide.

18. The fuel delivery system as defined by claim 1, wherein the throttle restriction comprises a slide valve and a housing including at least one guide portion for the valve slide, which guide portion located at least essentially outside a sealing region by means of which the housing of the throttle restriction is sealed off from the common housing.

19. The fuel delivery system as defined by claim 1, wherein the throttle restricting comprises a housing, a control opening, and a flat face in the housing in the region of the control opening.

20. The fuel delivery system as defined by claim 1, wherein the throttle restriction comprises a valve slide having a control edge and at least one control opening, and wherein an end face of the valve slide, in the region of the control edge, has a curved flow guide portion.
